(19) United States
(12) Patent Application Publication
(10) Pub. No.: US 2003/0027123 A1
(43) Pub. Date: Feb. 6, 2003

(54) APPARATUS AND PROCESS FOR PROJECTING COSTS ASSOCIATED WITH DELAYING PURCHASE OF INSURANCE

(75) Inventor: Stewart Bronaugh, Nashville, TN (US)

Correspondence Address: Jennifer A. Albert, Hunton & Williams, 1900 K Street, N.W., Suite 1200, Washington, DC, 20006-1109, US, jalbert@hunton.com, 202-955-1500, 202-778-2201

(73) Assignee: GE Financial Assurance Holdings, Richmond, 23230 (US)

(21) Appl. No.: 09/597,254

(22) Filed: Jun. 19, 2000

(51) Int. Cl. G09B 25/00

(52) U.S. Cl. 434/365

(57) ABSTRACT

### Abstract of the Disclosure

An apparatus demonstrating costs associated with a delay in obtaining insurance comprising an envelope containing a plurality of openings disposed therein, and an information card that slides into the envelope. The information card comprises a plurality of entries printed thereon wherein at least one of the entries is aligned with an opening in the envelope so as to demonstrate costs associated with the delay in obtaining insurance.

### Background of the Invention

The invention relates to a system and method for explaining the cost of delaying the purchase of insurance through use of a combined envelope and information card system which allows a sales agent to easily demonstrate the costs associated with delaying the purchase of insurance for varying ages of prospective customers.

Information relating to insurance can be very confusing for prospective customers of an insurance provider. This is particularly true for certain types of insurance products such as long term care insurance. In this and other types of insurance products, the mathematics involved in demonstrating the costs associated with obtaining the insurance coverage can be very confusing. The benefits of obtaining long term care insurance at an earlier time in a persons life are known. One of these benefits is that a person pays less total premiums for the same amount of insurance coverage if the person purchases the insurance coverage at an earlier age. For example, many publications discuss the options associated with long term care insurance and the benefits of obtaining that insurance at an earlier age in life. Some insurance providers may use internal software that prints out reports that demonstrate to sales agents those cost benefits. Nevertheless, sales agents have difficulty providing the concrete calculations to show a prospective customer exactly how much money may be saved.

Moreover, differences in a prospective customer's age vary the calculations. It is therefore difficult for a sales agent to easily quantify the numbers for the prospective customer. Additionally, long term care insurance is not widely distributed. The difficulty in explaining the benefits of such insurance product makes the sale much more complicated. These and other drawbacks exist with current systems.

### Summary of the Invention

An object of the present invention is to overcome these and other drawbacks of existing systems and methods.

Another object of the present invention is to provide a simple and quick method by which a sales agent can explain the benefits of obtaining insurance earlier in a person's life to a prospective customer.

Another object of the present invention is to provide an envelope and information card system whereby the sales agent may simply slide the card in the envelope so that the prospective customer's age is shown in an opening in the envelope and may readily demonstrate the amount of premiums and benefits associated with obtaining insurance based on current and future cost information that is displayed through other openings in the envelope.

Another object of the present invention is to provide a system that is hand-held and readily available to make it easier for the sales agent to bring along the current and future cost information directly to the prospective customer's location rather than using a complicated software program that employs a laptop computer or other electronic component.

Additional objects and advantages of the invention will be set forth in the description which follows, and in part will be obvious from the description, or may be learned by practice of the invention. The objects and advantages of the invention may be realized and attained by means of the instrumentalities and combinations particularly pointed out in the appended claims.

To achieve the objects and in accordance with the purposes of the invention, as embodied and broadly described herein, the invention, in one aspect, includes an apparatus for demonstrating costs associated with a prospective customer's delay in obtaining insurance that enables a sales agent to readily and easily demonstrate the benefits of obtaining insurance early in the prospective customer's life. The apparatus may be used by the sales agent in making sales of a plurality of types of insurance products including, for example, long term care insurance. According to one embodiment, the apparatus is comprised of an envelope containing a plurality of openings disposed therein; an information card that slides into the envelope, wherein the information card comprises a plurality of entries printed thereon; and wherein as least one of the entries is aligned with one of the openings in the envelope so as to demonstrate the costs associated with the prospective customer's delay in obtaining insurance. One of the openings in the envelope corresponds to a column on the card showing ages of the prospective customer. Another one of the openings in the envelope corresponds to an amount of premiums that the prospective customer would pay if purchasing a level of insurance coverage at the current time and another one of the openings corresponds to an amount of premiums that the prospective customer would pay to obtain the same level of insurance coverage if such insurance coverage was purchased ten years thereafter or at any other predetermined amount of time later than the current time.

For each year of the prospective customer's age, there is a corresponding entry on the information card from each of the columns. The age and corresponding entries comprise a data set. When the age entry from a data set is displayed in the age opening on the envelope, the other entries from that data set appear in the other corresponding openings in the envelope.

Therefore, by sliding the card until the current age of the prospective customer to be insured appears in the age opening in the envelope, a comparison between a premium amount today and a premium amount ten years from now for obtaining the same level of insurance coverage can be made by the sales agent. The sales agent is not required to generate any complicated mathematics. Furthermore, another box or opening within the envelope may demonstrate the total premiums to be paid by the prospective customer if purchasing the level of insurance coverage now as opposed to ten years from now. In this embodiment, the cost of the premiums to be paid is drastically higher over the course of the payment cycle if the prospective customer's purchase of the insurance coverage is delayed as opposed to a situation in which the prospective customer purchases the same level of insurance coverage at the current time.

Accordingly, through use of the system and method of the present invention, even an inexperienced sales agent can readily explain the benefits of obtaining long term insurance coverage at the current time as opposed to delaying purchase of such long term care insurance coverage until some point of time in the future. The information card and envelope system may be distributed to sales representatives, agents, and other representatives of a provider of insurance products to aid the provider's sales agents in increasing their sales of such insurance products. The envelope and information card are preferably hand-held and of a size of approximately 4 inches by 8 inches and therefore can fit within a sales agent's coat pocket or other location without being obtrusive. Furthermore, the entries on the information card are static. The sales agent avoids having to make calculations that might be incorrect as has occurred when sales agents have attempted to calculate the cost savings using a computerized program or other electronic device, such as a calculator. Also, because the amount of premiums for purchase of the same level of insurance coverage may change over time, the sales agent may simply be sent new substitute cards to slide into the same envelope rather than having to recalculate or reprogram a computer system. Additionally, a plurality of different cards may be provided to slide within the same envelope to therefore provide a wider range of options to use to demonstrate costs to the prospective customer.

The accompanying drawings, which are incorporated and constitute a part of this specification, illustrate embodiments of the present invention and, together with the description, serve to explain the principles of the invention.

### Brief Description of the Drawings

Fig. 1a depicts a combined envelope and information card system according to one embodiment of the present invention.

Fig. 1b depicts a combined envelope and information card system according to one embodiment of the present invention with the card slid partially out of the envelope.

Fig. 2 depicts an embodiment of an envelope according to the present invention.

Fig. 3 depicts an embodiment of an information card containing information relating to compound inflation options for prospective customers of ages 40 to 57 according to the present invention.

Fig. 4 depicts an embodiment of a compound inflation option information card for prospective customers of ages 58 to 69 according to the present invention.

Fig. 5 depicts an embodiment of an equal inflation option information card for prospective customers of ages 58 to 69 according to the present invention.

Fig. 6 depicts an embodiment of an equal inflation option information card for ages 63 through 73 according to the present invention.

Fig. 7 depicts a flow diagram of a process of selling insurance according to an embodiment of the present invention.

Fig. 8 depicts an electronic information system for use in explaining the costs associated with a delay in obtaining insurance according to an embodiment of the present invention.

### Detailed Description of Preferred Embodiments

Reference will now be made in detail to the present preferred embodiments of the invention, examples of which are illustrated in the accompanying drawings in which like reference characters refer to corresponding elements.

The present invention provides a combined envelope and information card system for demonstrating the benefits of obtaining an insurance product, such as long term care insurance, at the current time as opposed to some point in the future.

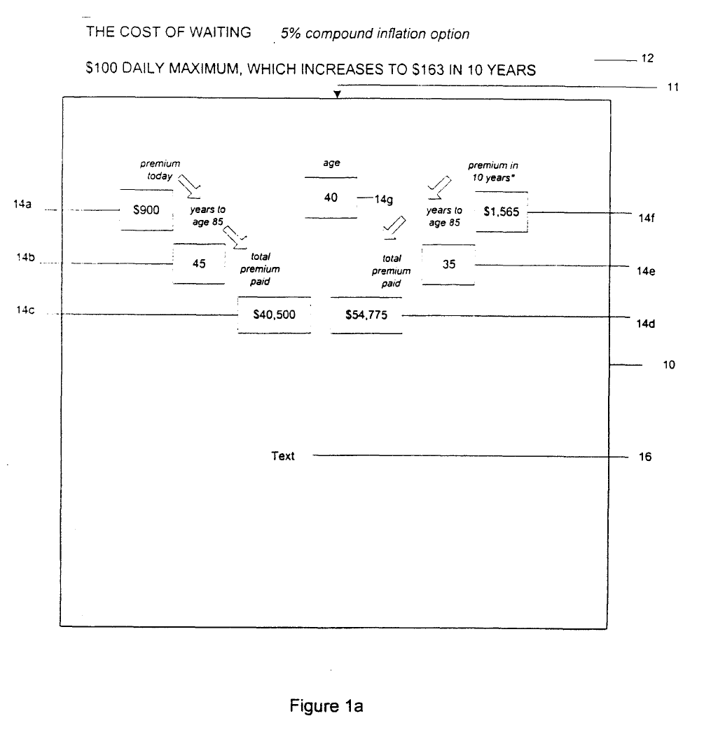

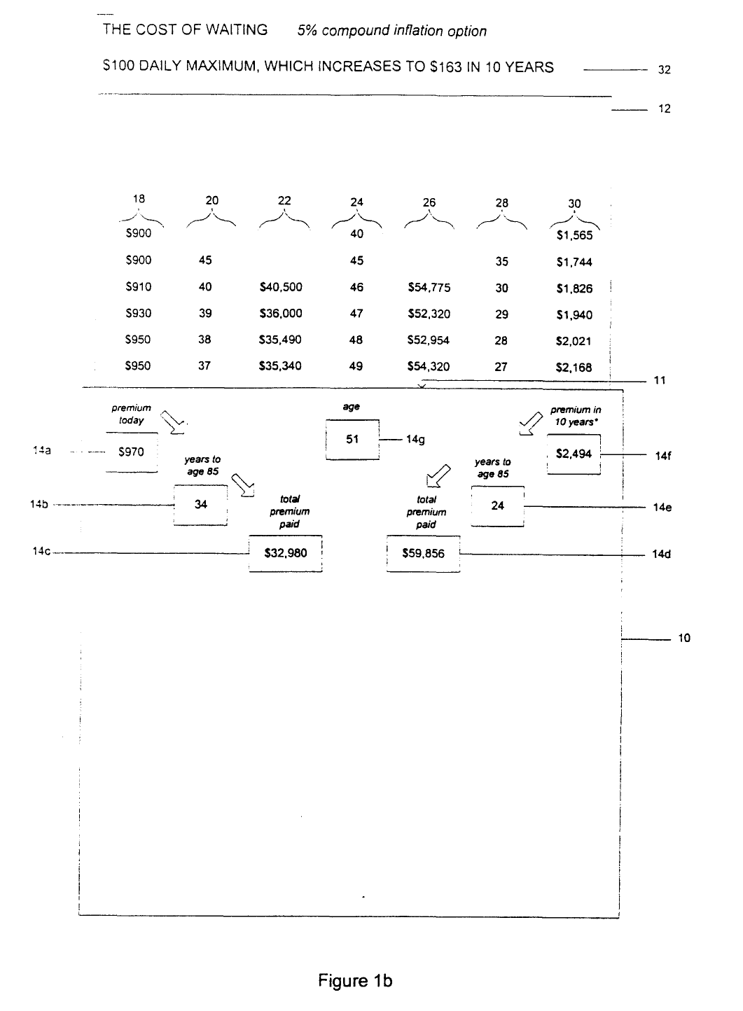

One embodiment of such a combined information card and envelope system is depicted in Figs. 1a and 1b. As shown in Fig. 1a, the system comprises an envelope 10 and an information card 12 that slides into envelope 10 through an upper portion or opening 11. Disposed within the envelope 10 are a plurality of openings 14 corresponding to a plurality of elements of a written portion of information card 12. In one embodiment of the present invention, seven different openings 14 may be provided in envelope 10 for a sales agent of an insurance provider to use to demonstrate the costs associated with a delay in purchasing a long term care insurance product. Specifically, a current premium opening 14a may be provided to demonstrate a premium amount that a prospective customer would pay at the current time if obtaining a certain level of long term care insurance coverage. Another years-to-stop-age opening 14b may be provided in envelope 10 to correspond to information from information card 12 relating to the number of years to a predetermined premium termination age (e.g., age 85) from the prospective customer's current age. Another total current premium opening 14c may be provided in envelope 10 corresponding to information on card 12 showing a total premium amount to be paid by the prospective customer from the current date until the prospective customer reaches the predetermined premium termination age of 85. Similarly, a future premium opening 14f may be provided in envelope 10 that corresponds to information from card 12 that demonstrates a premium amount that the prospective customer would pay if obtaining the same level of long term care insurance coverage at some predetermined point in the future. In the embodiment of Figs. 1a and 1b, for example, the predetermined point in the future may be 10 years from the present date. It should be appreciated, however, that any other predetermined point in the future may be selected to demonstrate the costs of delaying purchase of the long term care insurance coverage. Next, a future years-to-stop-age opening 14e may be provided in envelope 10 that corresponds to information on information card 12 relating to the number of years to the predetermined premium termination age (e.g., age 85) from the same predetermined point in the future (e.g., 10 years from the present time). Next, a total future premium opening 14d may be provided in envelope 10 corresponding to a total amount of premiums to be paid if the prospective customer purchases the certain level of long term care insurance coverage at the predetermined point in the future (e.g., 10 years from the present date). Also, an age opening 14g may be provided in envelope 10 that corresponds to information on card 12 related to a current age of the prospective customer. It should also be appreciated that additional text or instructions may be provided as text 16 or instructions on the envelope 10, either on a front portion or a back portion of the envelope 10, to aid the sales agent in understanding how to use the card or to provide the sales agent with other tactics or tips to use in the sale of insurance products.

As Fig. 1b demonstrates, card 12 slides in and out of envelope 10 through opening 11. Card 12 may comprise a plurality of information portions corresponding to openings 14 in envelope 10. Specifically, a heading portion 32 may be provided that indicates an option of a specific insurance product having a specified inflation factor being demonstrated.

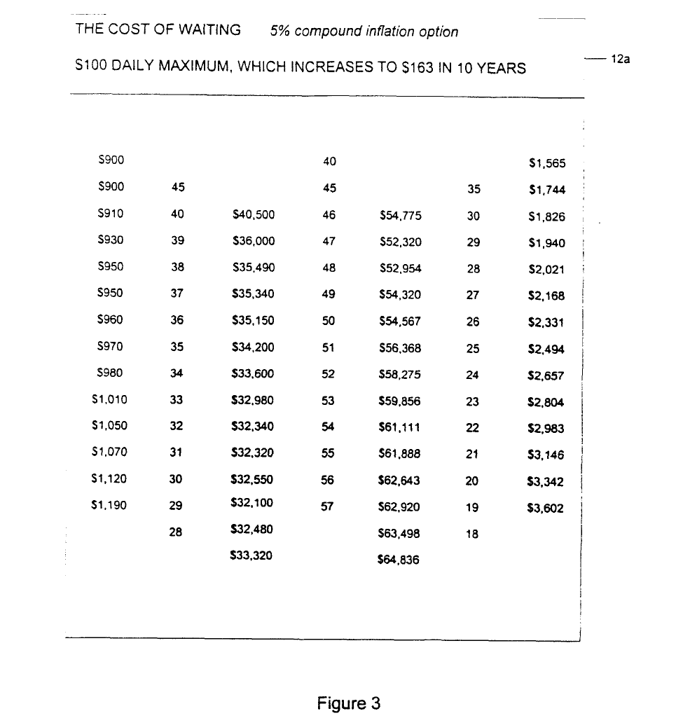

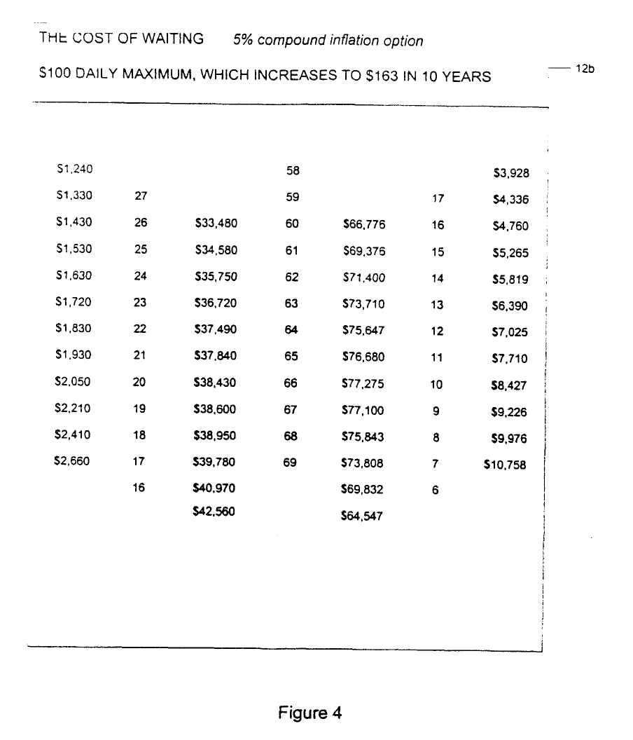

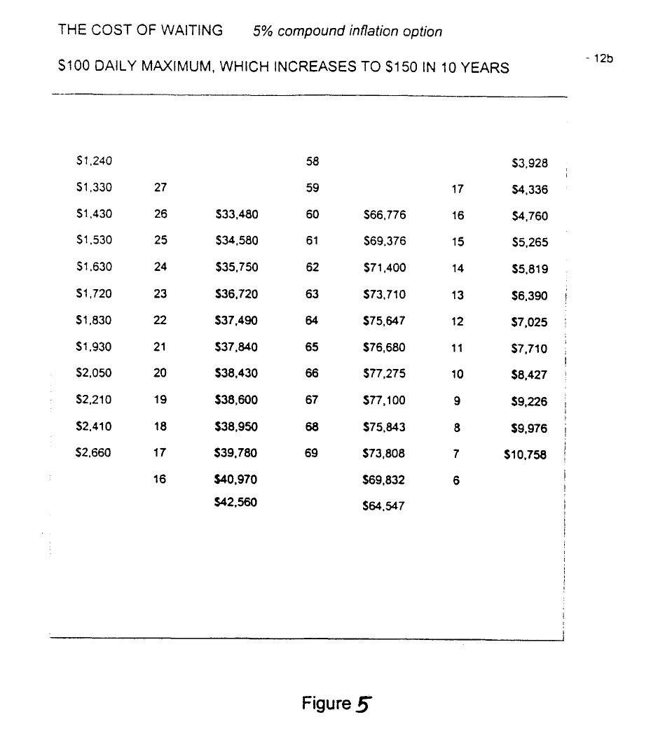

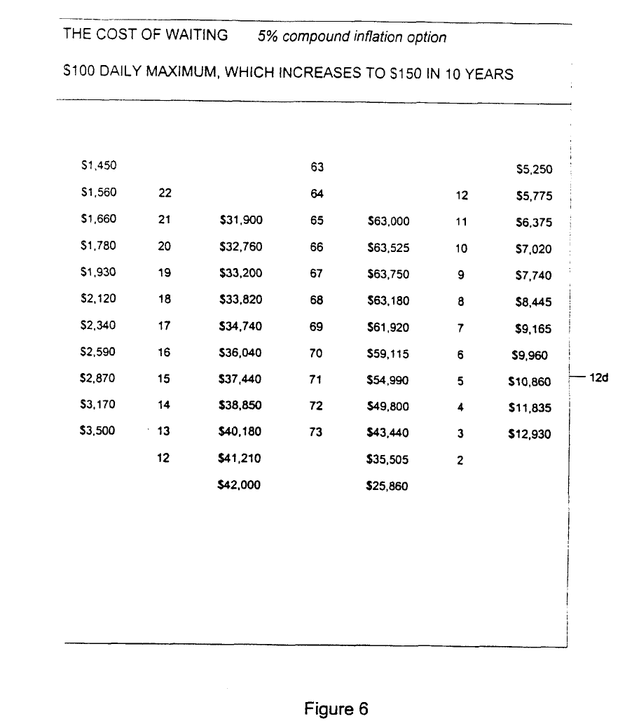

As shown in Fig. 1a, in one embodiment, information card 12 may be longer than envelope 10 so that heading 32 is disposed outside of envelope 10 even when information card 12 is fully disposed in (i.e., slid into) envelope 10. In the embodiment of Figs. 1a and 1b, a 5% compound inflation option is being demonstrated. The same information is demonstrated in Fig. 3. Fig. 4 depicts an embodiment of the same 5% compound inflation option for use with prospective customers having current ages 58 to 69 which may be disposed on the back of card 12a or may comprise a completely separate card according to preferences. Additionally, another card 12, such as the card 12c depicted in Fig. 5 demonstrating a 5% equal inflation option, may be used with prospective customers of ages 58 to 69, and card 12d, depicted in Fig. 6, illustrating a 5% equal inflation option, may be used with prospective customers of ages 63 to 73. Additional or different cards may be provided according to the knowledge of those of ordinary skill in the art.

As shown in Fig. 1b, additional information portions of information card 12 may be provided. Specifically, a column of a plurality of current premium amounts 18 may be presented on information card 12 at a location on information card 12 such that, when information card 12 is slid into opening 11 of envelope 10, one of the plurality of current premium amounts 18 may be displayed through opening 14a in envelope 10. Additionally, a plurality of years-to-age 85 entries may be provided on information card 12 as depicted in column 20 at a location on information card 12 such that, when information card 12 is slid into opening 11 in envelope 10, one of the plurality of years-to-age 85 entries is displayed in years-to-stop-age opening 14b in envelope 10. Also, a plurality of total premiums paid entries is provided in column 22 at a location on information card 12 such that, when information card 12 is slid into opening 11 in envelope 10, one of the plurality of total premiums paid entries is displayed through total premiums paid opening 14c in envelope 10. Column 24 on card 12 provides a plurality of age entries that may be presented through opening 14g in envelope 10 for indicating the current age of the prospective customer to whom the sales agent is using the apparatus to demonstrate the costs of obtaining long term care insurance coverage. Column 26 contains a plurality of entries corresponding to the total premiums to be paid if the prospective customer were to obtain the certain level of insurance coverage at the predetermined point in the future (e.g., 10 years from the present time). The entries of column 26 are positioned at a location on information card 12 such that, when information card 12 is slid through opening 11 of envelope 10, one of the entries of column 26 is displayed through total future premiums paid opening 14d in envelope 10.

Column 28 contains a plurality of entries indicating the years-to-age 85 of the prospective customer if such prospective customer purchases the certain level of insurance coverage at the predetermined point in the future rather than at the current time. Column 28 is located at a position on information card 12 such that, when information card 12 is slid into envelope 10 through opening 11, one of the plurality of entries in column 28 is displayed through years-to-stop-age opening 14e on envelope 10. In column 30, a plurality of entries is provided that indicate an amount of premiums that would be paid if the prospective customer waits the predetermined period of time before purchasing the certain level of insurance coverage. The entries of column 30 are positioned at a location on information card 12 such that, when information card 12 is slid into envelope 10 through opening 11, one of the plurality of entries in column 30 is displayed through future premiums to be paid opening 14f in envelope 10.

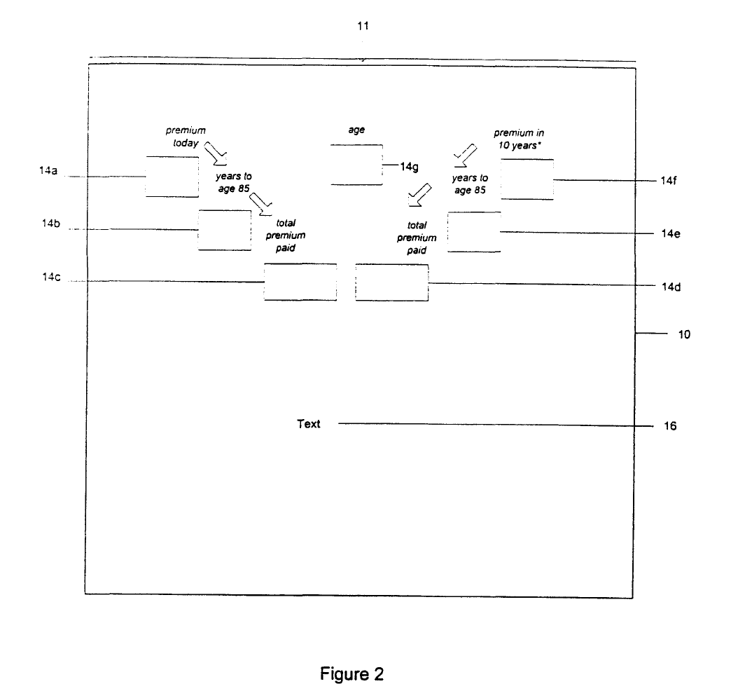

According to one embodiment of the present invention, an information set comprises one entry from each of the columns on information card 12 including columns 18, 20, 22, 24, 26, 28, and 30. The entries of the information set preferably are aligned on information card 12 in a manner such that when information card 12 is slid through opening 11 in envelope 10, the entries of the information set are displayed together in each of the openings 14 of envelope 10. For example, referring to Figs. 1a, 1b, and 2, it should be appreciated that one information set may comprise the future premium - $900 in column 18; age to 85 entry - 45 in column 20; total premium paid - $40,500 in column 22; current age - 40 in column 24; total premium paid - $54,775 in column 26; age to 85 - 35 in column 28; and premium in ten years entry - $1,565 in column 30. As illustrated in Fig. 1a, these entries all align with the corresponding openings 14 in envelope 10 when information card 12 is slid through opening 11 into envelope 10. Therefore, when the sales agent trying to sell long term care insurance to the prospective customer determines the prospective customer's current age, the sales agent may slide the information card 12 into envelope 10 until age 40 is shown in age opening 14g. At that point, the sales agent can explain that the current amount of annual premium that the prospective customer would pay for obtaining the certain level of insurance coverage is $900 and that, over the next 45 years, the total amount of premiums to be paid by the prospective customer would be $40,500. The sales agent may then explain that if the prospective customer delays purchase of the certain level of insurance coverage until ten years from now when the prospective customer is age 50, the annual premium to be paid by the prospective customer would be $1,565 and over the next 35 years from that point, the total amount of premiums to be paid by the prospective customer would be $54,775. As these entries of the information set illustrate, the cost savings is approximately $14,275 if the prospective customer obtains the certain level of insurance coverage at the current time as opposed to delaying purchase until ten years from now, when the prospective customer is age 50.

Because only one information set may be displayed through the openings 14 on envelope 10 at any one time, it is very difficult for the prospective customer or the sales agent to become confused and read off the wrong numbers. Also, the information card 12 and accompanying apparatus may be modified to be used for prospective customers of many different ages, thereby making the system easy to use with multiple prospective customers or to show such multiple prospective customers what the differences in the costs associated with the purchase of a certain level of insurance coverage at different ages of any prospective customer's life. For example, as shown in Fig. 1b, if the prospective customer were instead age 51, the information set on information card 12 corresponding to age 51 may be displayed through the openings 14 of envelope 10 by simply sliding card 12 out of envelope 10 until age 51 is displayed in age opening 14g of envelope 10. At that point, the sales agent could explain that the annual premium to be paid by the prospective customer would be $970 if the prospective customer purchased the certain level of insurance coverage at the current time and would pay a total premium of $32,980 as opposed to waiting ten years before purchasing the certain level of insurance coverage whereby the annual premium would be $2,494 for a total premium to be paid of $59,856.

It also should be appreciated that multiple different types of insurance coverages may be offered for purchase by the sales agent, each having different premiums associated therewith. In each of these insurance coverages, however, there is still a cost benefit for obtaining the insurance coverage at the current time as compared to delaying purchasing such coverage until some time in the future. Therefore, the system of the present invention may be employed using different information cards to illustrate the different premium rates associated with the different types of insurance coverages. Multiple information cards 12 as depicted in Figs. 2, 3, 4, 5 and 6 may be provided, each of which may slide into the same envelope 10. Thus, the system of the present invention may actually comprise one envelope 10 and a plurality of information cards 12. It should also be appreciated that an information card 12 may be provided having information printed on both a front surface and a back surface of the information card 12 to reduce the total number of information cards 12 that the sales agent would have to carry on a sales call to adequately demonstrate a multiplicity of different types of insurance coverage to a prospective customer.

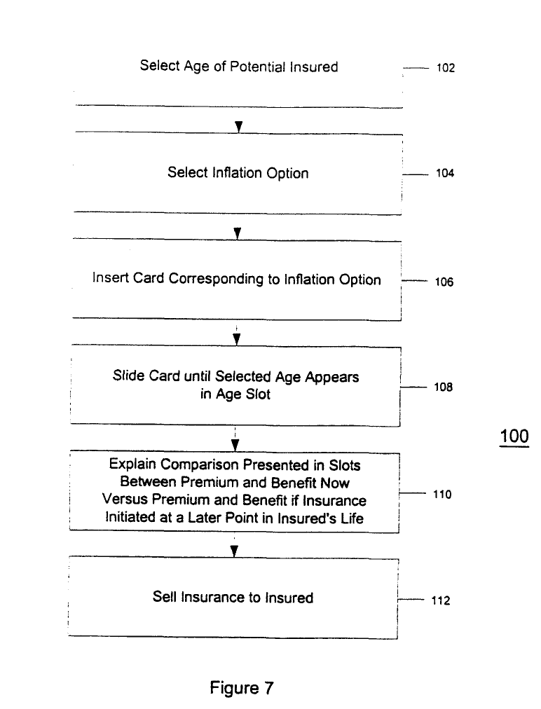

Additionally, a method 100 of selling insurance coverage, such as long term care insurance coverage, is hereby provided as, for example, shown in Fig. 7. Specifically, in a first step 102 of the method 100, a sales agent attempting to sell the insurance coverage to a prospective customer determines the age of the prospective customer at the current time. Next, in step 104, the inflationary rate for an insurance option desired to be demonstrated to the prospective customer is selected. Of course, multiple different insurance coverage options may be demonstrated and each of such coverage options may have different inflationary rates associated therewith and therefore the steps of the method 100 may be repeated to demonstrate each option. Once the coverage option and the inflation rate and the current age of the prospective customer are determined, the sales agent selects the information card 12 corresponding to the selected insurance option and having the prospective customer's age printed thereon. In step 108, the selected information card 12 is then inserted through opening 11 into envelope 10 and slid until the prospective customer's current age from the set of information entries in column 24 on the information card is displayed in opening 14g. Next, in step 110, the sales agent compares the premium amounts presented in the openings 14a and 14e of envelope 10 illustrating the amounts of premiums that the prospective customer would have to pay if the insurance coverage were purchased at the current time versus the amounts of premiums as displayed through openings 14d and 14f if the prospective customer purchased the same insurance coverage at some predetermined point in the future. As used for illustration purposes in the examples provided herein, the predetermined point of time in the future is ten years from the current time and the various calculations demonstrate that the annual premiums to be paid and the total premiums to be paid would be significantly higher if the prospective customer waits to obtain the insurance coverage until after those ten years have elapsed. Next, in step 112, based on the displayed information, the sales agent is able to sell the insurance coverage to the prospective customer by demonstrating the additional costs to be incurred by the prospective customer if the purchase of such insurance coverage was delayed.

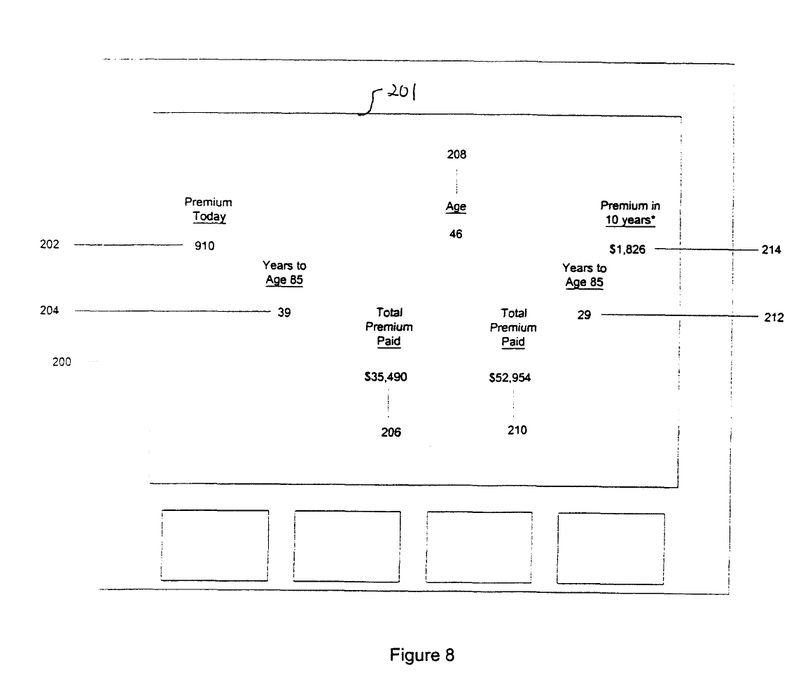

It should be appreciated that, although an envelope and card system has been described herein, an electronic version of the system of the present invention may also be employed. An example of an electronic system is depicted in Fig. 8 whereby a personal digital assistant 200 is provided with a display 201 corresponding to the plurality of entries provided in information card 12 and displayed through the plurality of openings 14 in envelope 10. Specifically, a current premium 202 is depicted as element 201, the years-to-age 85 for the prospective customer is displayed as element 204, the total premium to be paid if the prospective customer purchases the insurance coverage today is displayed as element 206, the prospective customer's current age is displayed as element 208, the total premium to be paid if the prospective customer delays the purchase of the insurance coverage by a predetermined period of time is depicted as element 210, the period of years-to-age 85 for the prospective customer after the predetermined period of time has elapsed is displayed as element 212, and the premium to be paid by the prospective customer if the purchase of the insurance coverage is delayed by the predetermined period of time is displayed as element 214. A database having stored therein the entries as shown in cards 12 may be provided whereby the sales agent simply inputs the prospective customer's current age and the desired insurance option into the system, and the entries 202-214 are retrieved from the database and are displayed within display 201 of the personal digital assistant 200. Other electronic devices such as personal computers, laptop computers, cellular mobile phones, etc. may also be utilized for implementation of the system and process of the present invention. Specifically, any electronic component that provides a graphical user interface on which this information may be presented may be used according to another embodiment of the present invention.

While suitable material may be used for constructing information card 12 and envelope 10, a cardboard structure may be provided to reduce the expense of manufacturing the combined card 12 and envelope 10 sets, thereby enabling distribution of these card/envelope sets to a large number of agents in a relatively inexpensive manner. Moreover, the increased sales that may be derived from use of the system of the present invention to explain the benefits to prospective customers greatly outweighs such manufacturing costs. Furthermore, as can be appreciated by one of the ordinary skill in this field, the card/envelope sets may be made in smaller or larger sizes as desired. For example, an insurance provider may desire to provide a wallet-sized information card and envelope system that fits within the sales agents' wallets so that a sales agent may carry a card/envelope set at all times and not have to worry about fitting it into a briefcase or in a coat pocket, etc. Furthermore, although the openings 14 in envelope 10 have been depicted as boxes in the illustrative examples herein, other shapes and sizes for the openings 14 may also be employed. Moreover, the arrangement of the openings 14 and the entries on the information cards 12 may be modified as desired to provide different arrangements according to the aesthetic tastes of the insurance provider issuing the card/envelope sets. For example, the entries of information card 12 may be displayed through circular openings in envelope 10, or, instead of arranging the entries on information card 12 in columns, such entries could be arranged in rows or diagonally, for example.

Additionally, whereas a single opening 11 is provided in the top of envelope 10, it should be appreciated that the opening 11 used to slide the information card 12 into envelope 10 may be placed on any one of the multiple sides of envelope 10. Alternatively, envelope 10 may be comprised of a single overlay that fits over a top of the information card 12 and therefore the information card 12 does not slide into an opening 11, but rather the template or overlay would fit over the top of card 12.

It should also be appreciated that any different color scheme for information cards 12 and envelopes 10 may be used corresponding to themes or other marketing campaigns for the insurance provider. Also, the sales agent may desire to leave the information card/envelope system with the prospective customer upon conclusion of a sales call so that the prospective customer can test different cost/benefit scenarios at the prospective customer's convenience.

Additionally, it should be appreciated that the invention described herein may be used for purposes of demonstrating costs/benefits associated with any insurance product, investment vehicle, or the like, in which costs to the prospective customer increase with delays in purchase times, including such insurance products as long term disability, life insurance, long term care insurance, etc. The present invention is particularly useful for insurance products for which the premium costs escalate as the prospective customer's age increases.

Although a detailed description of the preferred embodiments has been provided, the scope of the invention is not limited thereby. Various changes and modifications within the scope of the invention will be readily apparent by those skilled in the art as defined by the appended claims.

Claims

1. An apparatus for demonstrating costs associated with a prospective customer's delay in purchasing insurance comprising:
an envelope containing a plurality of openings disposed therein;
an information card that slides into the envelope, the information card comprising a plurality of entries printed thereon; and
wherein at least one of the entries is aligned with one of the openings in the envelope so as to demonstrate the costs associated with the prospective customer's delay in purchasing the insurance.

2. The apparatus of claim 1 wherein the plurality of entries comprises a plurality of sets of demonstration data;
wherein each one of the plurality of sets of demonstration data includes a predetermined number of entries; and
wherein each entry in one of the plurality of sets corresponds to one of the openings in the envelope.

3. The apparatus of claim 2 wherein each one of the plurality of sets of demonstration data comprises an entry for the prospective customer's current age, a current cost of obtaining insurance and a future cost of obtaining insurance.

4. The apparatus of claim 3 wherein the envelope has an opening that aligns with the current age entry, an opening that aligns with the current cost entry and an opening that aligns with the future cost entry of one of the plurality of sets of demonstration data on the information card to demonstrate the cost savings of obtaining insurance at the current time.

5. The apparatus of claim 3 wherein each set of demonstration data further comprises an entry for a total amount of premiums to be paid by the prospective customer if initiating a purchase of the insurance at the current time and an entry for a total amount of premiums to be paid by the prospective customer if waiting until a predetermined period of time has elapsed prior to initiating a purchase of the insurance.

6. The apparatus of claim 5 wherein the envelope has an opening that aligns with the entry for the total amount of premiums to be paid by the prospective customer if initiating the purchase of the insurance at the current time and an opening that aligns with the entry for the total amount of premiums to be paid by the prospective customer if waiting until after a predetermined period of time has elapsed prior to initiating the purchase of the insurance.

7. The apparatus of claim 5 wherein each set of demonstration data further comprises an entry for a number of years from the prospective customer's current age until a predetermined insurance premium termination age and an entry for a number of years from the prospective customer's age after the predetermined period of time has elapsed until the predetermined insurance premium termination age.

8. The apparatus of claim 7 wherein the envelope has an opening that aligns with the entry for the number of years from the prospective customer's current age until the predetermined insurance premium termination age and an opening that aligns with the entry for the number of years from the prospective customer's current age after the predetermined period of time has elapsed until the predetermined insurance premium termination age.

9. The apparatus of claim 1 comprising a plurality of information cards wherein any one of said plurality of information cards may be slid into the envelope.

10. The apparatus of claim 1 wherein the information card comprises a front portion and a back portion, wherein each of the front portion and the back portion may include a plurality of entries printed thereon.

11. A method for selling insurance using an envelope containing a plurality of openings disposed therein and an information card that slides into an opening in the envelope, the information card comprising a plurality of sets of information entries printed thereon wherein at least one of the information entries is aligned with one of the openings in the envelope so as to demonstrate costs associated with a delay in obtaining insurance, wherein each set of information entries comprises an entry for a prospective customer's current age, an entry for a current cost of obtaining insurance and an entry for a future cost of obtaining insurance, the method comprising the steps of:
identifying the prospective customer's current age;
sliding the information card in the envelope until the entry for the prospective customer's current age is displayed in one of the openings in the envelope; and
expressing the current cost of obtaining insurance and the future cost of obtaining insurance from the set of information entries for the current age to highlight cost savings if the prospective customer obtains the insurance at the current time.

12. The method of claim 11 wherein the insurance is a long term care insurance product.

13. The method of claim 11 wherein the plurality of sets of information entries is comprised of a plurality of sets of demonstration data;
wherein each one of the sets of demonstration data comprises a predetermined number of entries; and
wherein each of the predetermined number of entries in a set of demonstration data corresponds to one of the openings in the envelope.

14. The method of claim 13 wherein the envelope has an opening that aligns with the current age entry, an opening that aligns with current cost entry and an opening that aligns with the future cost entry of a set of demonstration data on the information card to demonstrate the cost savings of obtaining insurance at a current premium rate.

15. The method of claim 13 wherein each set of demonstration data further comprises an entry for the total premiums to be paid by the prospective customer if initiating a purchase of insurance at the current time and an entry for total premiums to be paid by the prospective customer if waiting until after a predetermined period of time has elapsed prior to initiating the purchase of the insurance.

16. The method of claim 15 wherein the envelope has an opening that aligns with the entry for the total premiums to be paid by the prospective customer if initiating the purchase of insurance at the current time and an opening that aligns with the entry for total premiums to be paid by the prospective customer if waiting until after the predetermined period of time has elapsed prior to initiating the purchase of insurance.

17. The method of claim 13 wherein each set of demonstration data further comprises an entry for a number of years from the prospective customer's current age until a predetermined insurance premium termination age and an entry for a number of years from the prospective customer's age after the predetermined period of time has elapsed until the predetermined insurance premium termination age.

18. The method of claim 17 wherein the envelope has an opening that aligns with the entry for the number of years from the prospective customer's current age until a predetermined insurance premium termination age and an opening that aligns with the entry for the number of years from the prospective customer's age after the predetermined period of time has elapsed until the predetermined insurance premium termination age.

19. The method of claim 11 wherein a seller offers a plurality of different types of insurance options;
wherein a plurality of the information cards are available, each of the plurality of information cards corresponding to one of the plurality of different types of insurance options; and
further comprising the step of selecting one of the plurality of information cards to insert into the envelope.

20. An apparatus for demonstrating costs associated with a delay in obtaining insurance comprising:
an information card including a plurality of informational entries printed on a surface thereof; and
an overlay including a plurality of openings disposed therein, said overlay being positioned over the surface of said information card; and
wherein at least one of the informational entries is aligned with one of the openings in the overlay so as to demonstrate costs associated with the delay in obtaining the insurance.

21. The apparatus of claim 20 wherein the plurality of informational entries comprises a plurality of sets of demonstration data;
wherein each set of demonstration data comprises a predetermined number of entries; and
wherein each set of demonstration data is located on the information card such that, when the overlay is laid over the surface of the information card, one of the plurality of the entries in each of the sets is displayed through a corresponding one of the openings in the overlay.

22. The apparatus of claim 21 wherein each set of demonstration data comprises an entry for a prospective customer's current age, a current cost of obtaining the insurance and a future cost of obtaining the insurance.

23. The apparatus of claim 22 wherein the overlay has an opening that aligns with the entry for the prospective customer's current age, an opening that aligns with the current cost entry and an opening that aligns with the future cost entry of one of the sets of demonstration data on the information card to demonstrate the cost savings of obtaining the insurance at the current time compared to a future point in time.

24. The apparatus of claim 22 wherein each set of demonstration data further comprises an entry for total premiums to be paid by the prospective customer if initiating a purchase of insurance at the current time and an entry for total premiums to be paid by the customer if the purchase of insurance was delayed until after a predetermined period of time has elapsed.

25. The apparatus of claim 24 wherein the overlay has an opening that aligns with the entry for the total premiums to be paid by the prospective customer for the insurance at the current time and an opening that aligns with an entry for total premiums to be paid by the prospective customer if the purchase of the insurance was delayed until after a predetermined period of time had elapsed.

26. The apparatus of claim 25 wherein each set of demonstration data further comprises an entry for a number of years from the prospective customer's current age until a predetermined insurance premium termination age and an entry for a number of years from the prospective customer's age after the predetermined period of time has elapsed until the predetermined insurance premium termination age.

27. The apparatus of claim 26 wherein the overlay has an opening that aligns with the entry for the number of years from the prospective customer's current age until the predetermined insurance premium termination age and an opening that aligns with the entry for the number of years from prospective customer's age after the predetermined period of time has elapsed until the predetermined insurance premium termination age.

28. A hand-held apparatus for demonstrating costs associated with a delay in obtaining insurance comprising:
a chart comprising a plurality of sets of demonstration data, each of said plurality of sets of demonstration data related to a particular age for a prospective customer; and
display means for selectively presenting one of the plurality of sets of demonstration data corresponding to the current age of the prospective customer, the selective presentation of the one set of demonstration data providing information showing the costs associated with the delay in obtaining insurance.

29. The apparatus of claim 28 wherein each set of demonstration data comprises an entry for the prospective customer's current age, a current cost of obtaining the insurance and a future cost of obtaining the insurance.

30. The apparatus of claim 28 wherein each set of demonstration data further comprises an entry for a total amount of premiums to be paid by the prospective customer if initiating a purchase of the insurance at the current time and an entry for a total amount of premiums to be paid by the prospective customer if waiting until after a predetermined period of time has elapsed prior to initiating the purchase of the insurance.

31. The apparatus of claim 30 wherein each set of demonstration data further comprises an entry for a number of years from the prospective customer's current age until a predetermined insurance premium termination age and an entry for a number of years from the prospective customer's age after the predetermined period of time has elapsed until the predetermined insurance premium termination age.

32. An apparatus for demonstrating costs associated with a delay in obtaining insurance comprising:
an information card having a plurality of informational entries printed on a surface thereof; and
an overlay including a plurality of openings disposed therein, said overlay being positioned over the surface of said information card; and
wherein at least one of the entries on the surface of the information card is aligned with an opening in the overlay so as to demonstrate costs associated with the delay in a purchase of insurance.

33. The apparatus of claim 32 wherein the plurality of entries comprises a plurality of sets of demonstration data;
wherein each set of demonstration data comprises a predetermined number of entries; and
wherein each of the predetermined number of entries in a set of demonstration data corresponds to one of the openings in the overlay.

34. The apparatus of claim 33 wherein each set of demonstration data comprises an entry for a prospective customer's current age, a current cost of obtaining insurance and a future cost of obtaining insurance.

35. The apparatus of claim 34 wherein the overlay has an opening that aligns with the entry for the prospective customer's current age, an opening that aligns with the current cost entry and an opening that aligns with the future cost entry of one of the sets of demonstration data on the information card to demonstrate the cost savings of obtaining insurance at the current time compared to a future point in time.

36. The apparatus of claim 34 wherein each set of demonstration data further comprises an entry for total premiums to be paid by the prospective customer if initiating a purchase of the insurance at the current time and an entry for total premiums to be paid by the prospective customer if waiting until after a predetermined period of time has elapsed prior to initiating a purchase of insurance.

37. The apparatus of claim 36 wherein the overlay has an opening that aligns with the entry for the total premiums to be paid by the prospective customer if initiating the purchase of the insurance at the current time and an opening that aligns with the entry for total premiums to be paid by the prospective customer if waiting until after the predetermined period of time has elapsed prior to initiating the purchase of the insurance.

38. The apparatus of claim 36 wherein each set of demonstration data further comprises an entry for a number of years from the prospective customer's current age until a predetermined insurance premium termination age and an entry for a number of years from the prospective customer's age after the predetermined period of time has elapsed until the predetermined insurance premium termination age.

39. The apparatus of claim 38 wherein the overlay has an opening that aligns with the entry for the number of years from the prospective customer's current age until the predetermined insurance premium termination age and an opening that aligns with the entry for the number of years from the prospective customer's age after the predetermined period of time has elapsed and the predetermined insurance premium termination age.
